(19) United States
(12) Patent Application Publication
(10) Pub. No.: US 2016/0063889 A1
(43) Pub. Date: Mar. 3, 2016

(54) WORD DISPLAY ENHANCEMENT

(71) Applicant: Ruben Rathnasingham, San Carlos, CA (US)

(72) Inventor: Ruben Rathnasingham, San Carlos, CA (US)

(21) Appl. No.: 14/837,489

(22) Filed: Aug. 27, 2015

Related U.S. Application Data
(60) Provisional application No. 62/042,548, filed on Aug. 27, 2014.

(51) Int. Cl. G09B 19/00; G09B 5/06

(52) U.S. Cl. CPC G09B 19/00; G09B 5/06

(57) ABSTRACT

A print display of words is presented in a display at a user device. An audio electrical signal is generated based on utterances of a user in speaking a word of the words. The utterances are matched to the word using the audio electrical signal and word associated utterance data. An emphasis display signal is generated based on the matching of the utterances to the word. A visual reference of the word is emphasized at the display based on the emphasis display signal.

### CROSS-REFERENCE TO RELATED APPLICATIONS

This application claims the benefit of U.S. Patent Provisional Application No. 62/042,548, filed Aug. 27, 2014, which is hereby incorporated by reference.

### BACKGROUND

An area of ongoing research and development is teaching. In particular using technology to aid in teaching is an area of ongoing research and development.

Other limitations of the relevant art will become apparent to those of skill in the art upon reading the specification and studying of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

In various implementations, a print display of words is presented in a display at a user device. Further, in various implementations, an audio electrical signal is generated based on utterances of a user in speaking a word of the words. In various implementations, the utterances are matched to the word using the audio electrical signal and word associated utterance data. Additionally, in various implementations, an emphasis display signal is generated based on the matching of the utterances to the word. In various implementations, a visual reference of the word is emphasized at the display based on the emphasis display signal.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for enhancing a display of uttered words

FIG. 2 depicts a diagram of an example of a system for matching utterances made by a user with words.

FIG. 3 depicts a diagram of an example of a system for generating an instruction to emphasize a visual reference of a word displayed at a user device and read aloud by a user.

FIG. 4 depicts a diagram of an example of a system for controlling emphasis of visual references at a user device.

FIG. 5 depicts a flowchart of an example of a method for enhancing a display of uttered words.

FIG. 6 depicts a flowchart of an example of a method for enhancing a visual reference of a word in a display of words.

FIG. 7 depicts a flowchart of an example of a method for determining if an enhanced visual reference is for a word that is being uttered by a user.

### DETAILED DESCRIPTION

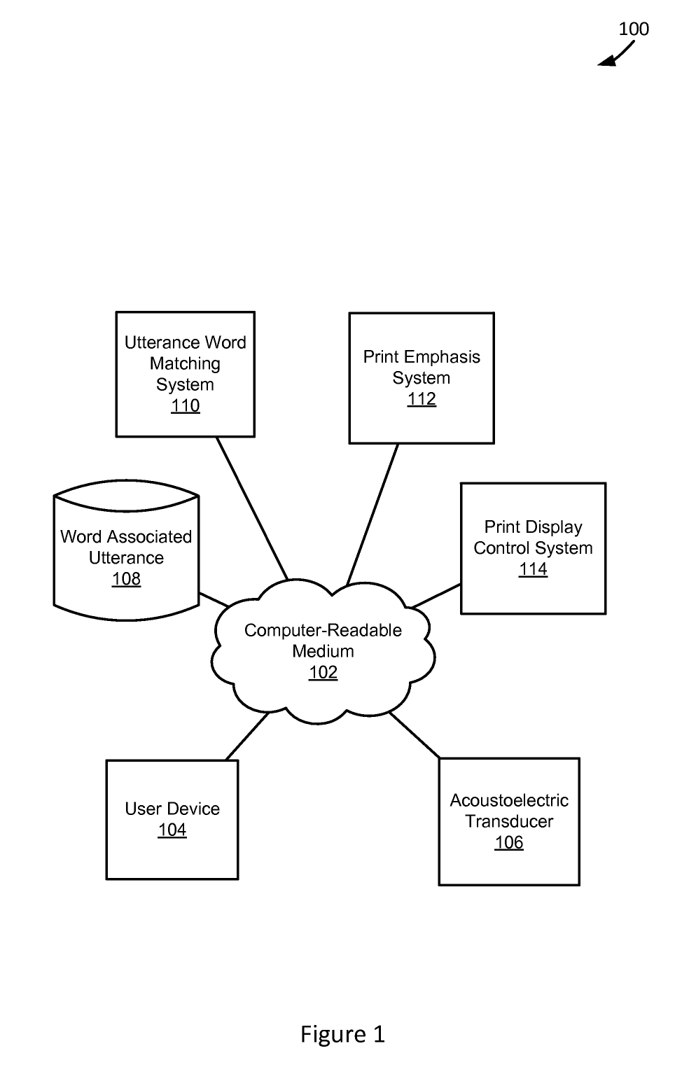

FIG. 1 depicts a diagram 100 of an example of a system for enhancing a display of uttered words. The system of the example of FIG. 1 includes a computer-readable medium 102, a user device 104, an acoustoelectric transducer 106, a word associated utterance datastore 108, an utterance word matching system 110, a print emphasis system 112, and a print display control system 114.

In the example system shown in FIG. 1, the user device 104, the acoustoelectric transducer 106, the word associated utterance datastore 108, the utterance word matching system 110, the print emphasis system 112, and the print display control system 114 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the user device 104, the utterance word matching system 110, the print emphasis system 112, the print display control system 114, and other applicable systems or devices described in this paper can be implemented as a computer system, a plurality of computer systems, or parts of a computer system or a plurality of computer systems. In general, a computer system will include a processor, memory, non-volatile storage, and an interface and the examples described in this paper assume a stored program architecture, though that is not an explicit requirement of the machine. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. A typical CPU includes a control unit, arithmetic logic unit (ALU), and memory (generally including a special group of memory cells called registers).

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

In stored program architectures, software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the user device 104 functions according to an applicable device for receiving text data used to display text. Depending upon implementation-specific or other considerations, the user device 104 can include or be coupled to a display for displaying text according to received text data. Further depending upon implementation-specific or other considerations, the user device 104 can include either or both a wired or wireless interface for receiving text data across a corresponding wired or wireless connection. The user device 104 can be a thin client device or an ultra-thin client device. Depending upon implementation-specific or other considerations, the user device 104 can include or be coupled to an electromechanical device capable of producing sound in response to an electrical audio signal. Further depending upon implementation-specific or other considerations, the user device 104 can be an EBook reader.

In a specific implementation, the acoustoelectric transducer 106 functions according to an applicable device for converting audio waves into an electrical audio signal. For example, the acoustoelectric transducer 106 can be a microphone. Depending upon implementation-specific or other considerations, the acoustoelectric transducer 106 can be integrated as part of the user device 104 or otherwise coupled to the user device 104. The acoustoelectric transducer 106 can convert utterances, made by a user in reading text displayed according to text data received by the user device 104, into an electrical audio signal.

In a specific implementation, the word associated utterance datastore 108 functions to store word associated utterance data. As user in this paper, word associated utterance data includes utterances associated with specific words. Utterances associated with a specific word can include one or a plurality of ways in which the specific word is pronounced when spoken. Word associated utterance data can include an expected electrical audio signal associated with a specific word. As used in this paper, an expected electrical audio signal associated with a specific word can be an electrical audio signal used to generate an utterance of the specific word. Depending upon implementation-specific or other considerations, an expected electrical audio signal associated with a specific word can be an electrical audio signal used to generate an utterance of the specific word in a correctly pronounced form. Further depending upon implementation-specific or other considerations, word associated utterance data can be generated based on an electrical audio signal received from the acoustoelectric transducer 106 of text spoken by a user of the user device 104 as the user reads text included as part of text data received by the user device 104. For example, a user can read text included as part of text data received by the user device 104 and the acoustoelectric transducer 106 can generate an electrical audio signal based on the user reading the text, which can be used to associate utterances with specific words included as part of the text read by the user.

In a specific implementation, word associated utterance data stored in the word associated utterance datastore 108 can be unique to a user. In being unique to a user, word associated utterance data can include expected electrical audio signals associated with specific words reflecting how the user pronounces the specific words. For example, if a user pronounces a specific word uniquely, then an expected electrical audio signal associated with the specific word, as is included as part of word associated utterance data, can be used to generate an utterance of the specific word according to the unique pronunciation of the specific word by the user. Depending upon implementation-specific or other considerations, in being unique to a user, word associated utterance data can include speech characteristics of the user. As used in this paper, speech characteristics of a user include features of the way a user talks. For example, speech characteristics of a user can include a tone, a rate, prosody, and a cadence of a user in speaking.

In a specific implementation, the utterance word matching system 110 can generate word associated utterance data based on received electrical audio signals. Depending upon implementation-specific or other considerations, the utterance word matching system 110 can generate word associated utterance data based on text data indicating specific words for which the utterance word matching system 110 can match utterances. In generating word associated utterance data, the utterance word matching system 110 can use applicable signal processing techniques for associating utterances with specific words. Word associated utterance data generated by the utterance word matching system 110 can include an expected electrical audio signal associated with a specific word.

In a specific implementation, the utterance word matching system 110 can generate word associated utterance data unique to a specific user. In being unique to a user, word associated utterance data can include an expected electrical audio signal associated with a specific word generated based on an electrical audio signal representing an utterance of the specific word by the user. For example, the utterance word matching system 110 can receive an electrical audio signal created by the acoustoelectric transducer 106 in response to the user uttering a specific word, and generate word associated utterance data for the specific word including the received electrical audio signal as the expected electrical audio signal associated with the specific word. As a result, the utterance word matching system 110 creates word associated utterance data that can be used to map utterances of a user to specific words based on the way the user pronounces the specific words.

In a specific implementation, the utterance word matching system 110 functions to generate word associated utterance data indicating speech characteristics of a user. The utterance word matching system 110 can determine speech characteristics of a user from electrical audio signals generated by the acoustoelectric transducer 106 in response to utterances made by the user. Depending upon implementation-specific or other considerations, the utterance word matching system 110 can determine speech characteristics of a user by comparing electrical audio signals representing a response by a user in uttering a specific word to expected electrical audio signals of the specific word in proper pronunciation.

In a specific implementation, the utterance word matching system 110 matches utterances made by a user while reading text with words included in the text using word associated utterance data. In matching utterances with words, the utterance word matching system can compare an electrical audio signal created in response to utterances made by a user, with expected electrical audio signals associated with a specific word. For example, if a received electrical audio signal is made in response to an utterance by the user of the word “elephant,” then the utterance word matching system 110 can match the utterance with the word “elephant” based on the received electrical audio signal and an expected electrical audio signal associated with the word “elephant.” Depending upon implementation-specific or other considerations, the utterance word matching system 110 can perform applicable signal processing on a received electrical audio signal in matching the received electrical audio signal with an expected electrical audio signal associated with a specific word. Example of applicable signal processing include: measurement and/or manipulation of signal amplitude, duration, slope, change in slope, or frequency response or content (spectrum) of the signal.

In a specific implementation, the utterance word matching system 110 can match a received electrical audio signal to an expected electrical audio signal according to applicable methods for matching signals. Examples of applicable methods of matching signals include frequency matching, amplitude matching, matching based on signal characteristics within a threshold. Depending upon implementation-specific or other considerations, in matching signals, the utterance word matching system 110 can remove representations in a received electric audio signal of gaps between utterances made by a user. In removing representations of gaps between utterances in a received electric audio signal, the utterance word matching system 110 can apply applicable filters, e.g. high pass filters, to remove the representations of the gaps between the utterances.

In a specific implementation, the utterance word matching system 110 can match an utterance of a portion of a specific word to the specific word using word associated utterance data. For example, if a user begins to utter the word “elephant” but only says the first portion of the word, then the utterance word matching system can match the utterance of the first portion of the word to the specific word “elephant.” The utterance word matching system 110 can match an utterance of a portion of a specific word to the specific word based on an electrical audio signal representing the utterance of the portion of the specific word.

In a specific implantation, the utterance word matching system 110 can match an utterance to a word or a portion of a word according to utterance matching parameters. As used in this paper, utterance matching parameters include parameters in which the utterance word matching system 110 operates in to match an electrical audio signal are matched to an expected electrical audio signal associated with a specific word. For example, utterance matching parameters can include thresholds or filters to apply when matching an electrical audio signal to an expected electrical audio signal associated with a specific word.

The print emphasis system 112 functions to generate an emphasis display signal instructing to emphasize a visual reference of a word when at least a portion of the word is uttered by a user. A visual reference of a word can include a print display of the word or a visual representation of a meaning of a word. For example, if a word is “elephant,” then a visual reference of the word can be a picture of an elephant. The print emphasis system 112 can generate an emphasis display signal for a word indicating to emphasize a visual reference displayed at a user device. As used in this paper, emphasizing a visual reference of a word includes an applicable method of increasing a visual prominence of a visual reference of a word, such as modifying either or both a background of the print display or the word or other words within the print display, or displaying or accentuating a visual representation of a meaning of the word. For example, emphasizing a visual reference of a word can include modifying a print display of the word by bolding the word, or changing colors of the word. In another example, emphasizing a visual reference of a word can include highlighting an image, or otherwise visual representation, of a meaning of the word.

In a specific implementation, the print emphasis system 112 can generate an emphasis display signal based on an electrical audio signal generated by the acoustoelectric transducer 106 representing an utterance of the word by the user. For example, the print emphasis system 112 can generate an emphasis display signal instructing to emphasize a print display of a word at a user device to which an utterance of the word represented in an electrical audio signal is matched by the utterance word matching system 110 using word associated utterance data.

In a specific implementation, the print emphasis system 112 functions to generate a continuous emphasis display signal for a string of words as the words are uttered, in an order in which the words are uttered. An emphasis display signal generated by the print emphasis system 112 for a string of words can be used to emphasize a visual representation of the words within a display of the words continuously as the words are read. An emphasis display signal is continuous in that it is continuously generated as a user reads words in a string of words to emphasize specific portions of a visual reference of the string of words, as the words are read by the user. For example, the print emphasis system 112 can continuously generate an emphasis display signal to emphasize a visual reference of each word in a visual reference of a string of words, as each word is read by a user. The print emphasis system 112 can generate an emphasis display signal based on an electrical audio signal generated by the acoustoelectric transducer 106 representing utterances of the words as they are spoken by a user. For example, if as a user reads the string of words “as the elephant runs,” the print emphasis system 112 can generate an emphasis display signal indicating to emphasize a visual representation of the words in the string of words in real-time as the user says the words within the string.

In a specific implementation, the print emphasis system 112 functions to generate an emphasis display signal indicating to emphasize a portion of a word in a print display of the word as portions of the word are uttered. A portion of a word can include a vowel, consonant, and/or a syllable that form the word. The print emphasis system 112 can generate an emphasis display signal indicating to emphasize a portion of a word in a print display of the word based on an electrical audio signal generated by the acoustoelectric transducer 106 representing an utterance of the portion of the word as it is spoken by a user. The print emphasis system 112 can generate an emphasis display signal indicating to emphasize a portion of a word included as part of text data to which an utterance of the portion of the word represented in an audio electric are matched by the utterance word matching system 110 using word associated utterance data.

In a specific implementation, the print emphasis system 112 functions to generate an electrical audio signal used in producing a sound of a word or a portion of the word. The print emphasis system 112 can generate an electrical audio signal used in producing a sound of a word or a portion of the word at the user device 104. An electromechanical device capable of producing sound in response to an electrical audio signal either integrated as part of the user device 104 or coupled to the user device 104 can generate a sound of a word or a portion of the word using an electrical audio signal generated by the print emphasis system 112. Depending upon implementation-specific or other considerations, the print emphasis system 112 can generate an electrical audio signal used in producing a sound of a correct pronunciation of a word or a portion of the word. Further depending upon implementation-specific or other considerations, in producing a sound of a word or a portion of a word, learning to read and/or learning a language is facilitated.

In a specific implementation, the print emphasis system 112 functions to generate an electrical audio signal used in producing a sound of a word or a portion of the word in response to the word or the portion of the word being uttered by a user. Depending upon implementation-specific or other considerations, the print emphasis system 112 generates an audio signal used in producing a sound of an utterance of a word or a portion of a word as spoken by a user. For example, the print emphasis system 112 can generate an electrical audio signal used in reproducing the utterance of a user in speaking a word or a portion of a word. Further depending upon implementation-specific or other considerations, in reproducing to a user an utterance of the user in speaking a word or a portion of a word, the user can improve their pronunciation.

In a specific implementation, the print emphasis system 112 functions to generate display data used in displaying a visual representation of an electrical audio signal generated by the acoustoelectric transducer 106 of an utterance of a user in speaking a word or a portion of a word. Depending upon implementation-specific or other considerations, display data generated by the print emphasis system 112 can include data used in displaying a visual representation of an actual electrical audio signal generated by the acoustoelectric transducer 106 or a processed version of the actual electrical audio signal. Further depending upon implementation-specific or other considerations, display data generated by the print emphasis system 112 can include an expected electrical audio signal associated with a word, a portion of a word, or a plurality of words matched to an utterance made by a user using word associated utterance data. A user can compare a visual representation of an electrical audio signal generated by the acoustoelectric transducer 106 in response to the user uttering a specific word with a visual representation of the expected electrical audio signal associated with the specific word to facilitate learning to read and/or learning a language, e.g. to correct the user's pronunciation of the specific word.

In a specific implementation, the print emphasis system 112 functions to generate or collect display data used in presenting media to a user viewing a display of a word. Media, as used in this paper, can include text, graphics, animation video, audio, and games. Display data used in presenting media can include triggers associated with media specifying when to display the media and specific media to display. For example, display data can include a trigger to display twinkling stars when “twinkle twinkle little star” is spoken. Depending upon implementation-specific or other considerations, the print emphasis system 112 can generate or collect display data including a visual representation of a meaning of a word. For example, the print emphasis system 112 can collect an image of an elephant and generate display data to include the image of the elephant and a trigger specifying to display the image of the elephant when the word “elephant” is uttered.

The print display control system 114 functions to control a display of words as they are read by a user. In controlling a display of words, indicated by text data, the print display control system 114 can emphasize visual references of words or portions of words according to emphasis display signals. Depending upon implementation-specific or other considerations, the print display control system 114 can emphasize a print display of a word or a visual representation of a meaning of a word. For example, the print display control system 114 can display an image of an elephant after or as the word “elephant” is read by a user.

In a specific implementation, the print display control system 114 can provide interactive features for controlling a display by a user. Interactive features can include features, that when activated by a user, manipulate either or both what word or words are displayed and how the word or words are displayed. Examples of interactive features include pausing and resuming word emphasis of a word or words within a display of the word or words, displaying a new word or words in a display, and display of information or content related to a word. For example, the print display control system 114 can provide an interactive functionality whereby if a user selects the word “elephant,” then a picture of an elephant and/or information describing an elephant can be displayed. In another example, the print display control system 114 can provide an interactive functionality whereby if a user selects a next page icon, then words on the next page can be displayed, and the user can resume reading.

In an example of operation of the example system shown in FIG. 1, the user device displays words as part of a visual display from text data. In the example of operation of the example system shown in FIG. 1, the acoustoelectric transducer 106 generates an electrical audio signal based on an utterance made by a user of the user device in reading displayed words included as part of the text data. Further, in the example of operation of the example system shown in FIG. 1, the utterance word matching system 110 matches the utterance made by a user to a specific word using word associated utterances data. In the example of operation of the example system shown in FIG. 1, in matching the utterance to a specific word, the utterance word matching system 110 matches the electrical audio signal received from the acoustoelectric transducer 106 to an expected electrical audio signal associated with the specific word. Additionally, in the example of operation of the example system shown in FIG. 1, the print emphasis system 112 generates an emphasis display signal for the specific word matched by the utterance word matching system 110. In the example of operation of the example system shown in FIG. 1, the print display control system 114 emphasizes a visual reference of a word according to the emphasis display signal generated by the print emphasis system 112.

Advantageously, “print referencing” leads to improved reading skills in language learners and can be a valuable intervention for children with reading disorders like dyslexia. Techniques in this paper provide a technology-based approach to print referencing, as opposed to a teacher-training-based approach. The technology can also be applied to other fields such as music reading and mathematics.

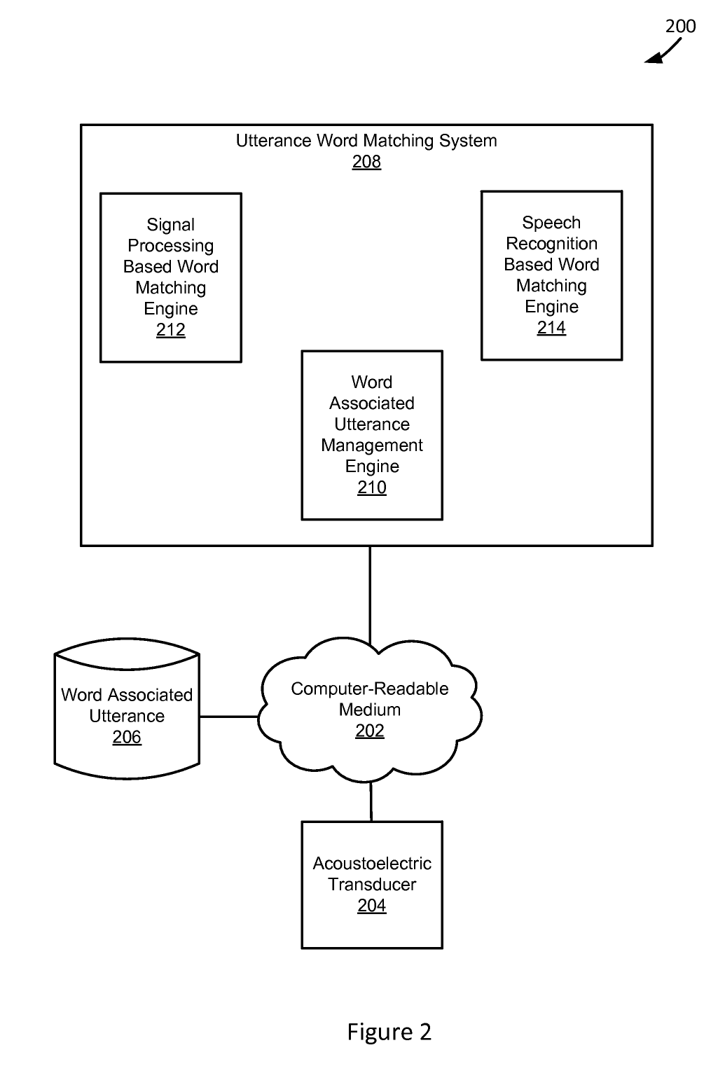

FIG. 2 depicts a diagram 200 of an example of a system for matching utterances made by a user with words. The example system shown in FIG. 2 includes a computer-readable medium 202, an acoustoelectric transducer 204, a word associated utterance datastore 206, and an utterance word matching system 208. In the example system shown in FIG. 2, the acoustoelectric transducer 204, the word associated utterance datastore 206, and the utterance word matching system 208 are coupled to each other through the computer-readable medium 202.

The acoustoelectric transducer 204 functions according to an applicable device for converting audio waves into audio electrical signals, such as the acoustoelectric transducers described in this paper. The acoustoelectric transducer 204 can convert utterances made by a user reading a visual display of words on a user device into audio electrical signals. Depending-upon implementation-specific or other considerations, the acoustoelectric transducer 204 can be implemented as part of a user device. For example, if a user device is a tablet, then the acoustoelectric transducer 104 can be a microphone integrated as part of the tablet.

The word associated utterance datastore 206 functions according to an applicable datastore for storing word associated utterance data, such as the word associated utterance datastores described in this paper. Word associated utterance data stored in the word associated utterance datastore 206 can include patterns of utterances associated with words generated according to an applicable speech recognition model, such as Hidden Markov models (hereinafter referred to as “HMM”). Depending upon implementation-specific or other considerations, word associated utterance data stored in the word associated utterance datastore 206 can include patterns of utterances specific to a user and identifiers indicating the patterns of utterances are associated with a specific user. For example, word associated utterance data stored in the word associated utterance datastore 206 can include patterns of utterances associated with words created according to an applicable speech recognition model specific for a specific user and an identifier indicating that the patterns of utterances are associated with the specific user. Word associated utterance data stored in the word associated utterance datastore 206 can include audio electrical signals associated with specific words. For example, word associated utterance data stored in the word associated utterance datastore 206 can include a waveform of an audio electrical signal typically generated when a user utters a specific word. Depending upon implementation-specific or other considerations, word associated utterance data stored in the word associated utterance datastore 206 includes a waveform of an audio electrical signal generated when a specific user utters a specific word and an identifier indicating the waveform is associated with the specific user.

The utterance word matching system 208 functions according to an applicable system for matching utterances made by a user with words, such as the utterance word matching systems described in this paper. The utterance word matching system 208 can match utterances made by a user with words using word associated utterance data. Depending upon implementation-specific or other considerations, the utterance word matching system 208 can match utterances with words using speech recognition. For example, the utterance word matching system 208 can match utterances with words according to patterns of utterances associated with words generating using an applicable speech recognition model. Further depending-upon implementation-specific or other considerations, the utterance word matching system 208 can match utterances with words based on waveforms of audio electrical signals generated when a user utters words. For example, the utterance word matching system 108 can match an utterance of a user to a word based on peaks in the waveform of an audio electrical signal generated based on the utterance. Depending upon implementation-specific or other considerations, the utterance word matching system 208 can use a combination of speech recognition and signal based matching. For example, the utterance word matching system 108 can initially match an utterance to a word based on a waveform of an audio electrical signal of the utterance and then apply the utterance to a pattern of utterances created according to an applicable speech recognition model to verify that the utterance is properly matched to the word.

The utterance word matching system 208 includes a word associated utterance management engine 210, a signal processing based word matching engine 212, and a speech recognition based word matching engine 214. The word associated utterance management engine 210 functions to manage word associated utterance data. In managing word associated utterance data, the word associated utterance management engine 210 can generate and/or update word associated utterance data.

In a specific implementation, the word associated utterance management engine 210 functions to generate word associated utterance data from generic data. Depending upon implementation-specific or other considerations, the word associated utterance management engine 210 can generate word associated utterance data that includes generic patterns of utterances associated with words created according to an applicable speech recognition model. For example, the word associated utterance management engine 210 can access a database that includes generic patterns of utterances for typical English words. Further depending upon implementation-specific or other considerations, the word associated utterance management engine 210 can generate word associated utterance data that include generic waveforms of audio electrical signals created when typical English words are spoken. For example, the word associated utterance management engine 210 can access a database that includes generic waveforms of audio electrical signals generated when typical English words are spoken.

In a specific implementation, the word associated utterance management engine 210 functions to update word associated data used in speech recognition based matching of words to utterances according to success of matching of words to utterances. Specifically, the word associated utterance management engine 210 can update word associated utterance data that includes patterns of utterances associated with words according to success of matching utterances with words. For example, if utterances are consistently matched incorrectly, then the word associated utterance management engine 210 can modify word associated utterance data to dissociate the utterances from the incorrect word. Depending upon implementation-specific or other considerations, the word associated utterance management engine 210 can modify word associated utterance data including patterns of utterances associated with words based on a specific user. For example if a specific user pronounces a word a specific way, then the word associated utterance management engine 210 can modify patterns of utterances associated with the word to reflect the specific pronunciation of the user. The word associated utterance management engine 210 can correlate patterns of utterances modified for a specific user with the user. As a result, specific patterns of utterances modified for a specific user can be utilized in matching words to utterances made by the user.

In a specific implementation, the word associated utterance management engine 210 functions to update word associated data used in signal processing based matching of words to utterances according to success of matching of words to utterances. Specifically, the word associated utterance management engine 210 can update word associated utterance data that includes waveforms of audio electrical signals created for spoken words according to success of matching utterances with words. For example, if utterances are consistently matched correctly, then the word associated utterance management engine 210 can modify word associated utterance data to associate the waveforms of the audio electrical signals with the correctly matched word. Depending upon implementation-specific or other considerations, the word associated utterance management engine 210 can modify word associated utterance data including waveforms of audio electrical signals associated with words based on a specific user. For example if a specific user pronounces a word a specific way, then the word associated utterance management engine 210 can modify waveforms of audio electrical signals associated with the word to reflect the specific pronunciation of the user. The word associated utterance management engine 210 can correlate modified waveforms of audio electrical signals for a specific user with the user. As a result, waveforms of audio electrical signals modified for a specific user can be utilized in matching words to utterances made by the user.

The signal processing based word matching engine 212 functions to match utterances to a word according to signal processing techniques. The signal processing based word matching engine 212 can match words to utterances based on waveforms of audio electrical signals created for the utterances and waveforms of audio electrical signals associated with the words. For example, the single processing based word matching engine 212 can match peaks in a received audio electrical signal created from utterances with peaks in waveforms of audio electrical signals associated with a word to match the utterance to the word. For example, if a waveform of an audio electrical signal for a user uttered word matches waveforms of at least one audio electrical signal associated with the word “elephant,” then the signal processing based word matching engine 212 can identify the user uttered word as “elephant.”

In a specific implementation, the signal processing based word matching engine 212 functions to match utterances to a word based on user specific word associated utterance data. Specifically, the signal processing based word matching engine 212 can use modified waveforms of audio electrical signals based on specific pronunciations of a user in matching waveforms of received audio electrical signals to words. The signal processing based word matching engine 212 can recognize a specific user before using word associated utterance data to match words to utterances made by the specific user. Depending upon implementation-specific or other considerations, the signal processing based word matching engine 212 can recognize a specific user from received input or a received audio electrical signal of utterance made by the specific user. For example, the word matching engine 212 can receive input indicating from a specific user indicating that the specific user is reading and making the utterances.

The speech recognition based word matching engine 214 functions to match utterances to a word according to speech recognition techniques. The speech recognition based word matching engine 214 can match words to utterances based on patterns of utterances associated with words indicated by word associated utterance data. For example, the speech recognition based word matching engine 214 can match utterances of words indicated by an audio electrical signal of the utterances with patterns of utterances to match the utterances with a word.

In a specific implementation, the speech recognition based word matching engine 214 functions to match utterances to a word based on user specific word associated utterance data. Specifically, the speech recognition based word matching engine 214 can use modified patterns of utterances for a specific user to match received audio electrical signals to words. The speech recognition based word matching engine 214 can recognize a specific user before using word associated utterance data to match words to utterances made by the specific user. Depending upon implementation-specific or other considerations, the speech recognition based word matching engine 214 can recognize a specific user from received input or a received audio electrical signal of utterance made by the specific user. For example, the word matching engine 214 can receive input indicating from a specific user indicating that the specific user is reading and making the utterances.

In a specific implementation, the signal processing based word matching engine 212 can match utterances to a word and the speech recognition based word matching engine 214 can verify that the utterances are matched to a correct word. For example, the single processing based word matching engine 212 can match utterances to a specific word based on a waveform of an audio electrical signal received for the utterances, and the speech recognition based word matching engine 214 can match the utterances based on patterns of utterances associated with words to verify that the utterances are correctly matched to the specific word. Depending upon implementation-specific or other considerations, the speech recognition based word matching engine 214 can disassociate the utterances with a specific word matched by the signal processing based word matching engine 212, if it determines that the utterances are incorrectly matched to the specific word.

In a specific implementation, the speech recognition based word matching engine 214 can match utterances to a word and the signal processing based word matching engine 212 can verify that the utterances are matched to a correct word. For example, the speech recognition based word matching engine 214 can match utterances to a specific word according to patterns of utterances associated with words, and the signal processing based word matching engine 214 can match a waveform of an audio electrical signal received for the utterances based to verify that the utterances are correctly matched to the specific word. Depending upon implementation-specific or other considerations, the signal processing based word matching engine 212 can disassociate the utterances with a specific word matched by the speech recognition based word matching engine 214, if it determines that the utterances are incorrectly matched to the specific word.

In an example of operation of the example system shown in FIG. 2, the acoustoelectric transducer 204 generates an audio electrical signal based on utterances made by a user reading a visual display including a string of text. In the example of operation of the example system shown in FIG. 2, the word associated utterance datastore 206 stores word associated utterance data used in matching the utterances to a specific word. Further, in the example of operation of the example system shown in FIG. 2, the word associated utterance management engine 210 generates and/or updates the word associated utterance data stored in the word associated utterance datastore 206. In the example of operation of the example system shown in FIG. 2, the signal processing based word matching engine 212 matches the utterances to the specific word based on a waveform of the audio electrical signal, indicated by the word associated utterance data stored in the word associated utterance datastore 206. Additionally, in the example of operation of the example system shown in FIG. 2, the speech recognition based word matching engine 214 matches the utterances to the specific word based on patterns of utterances associated with words, indicated by the word associated utterance data stored in the word associated utterance datastore 206.

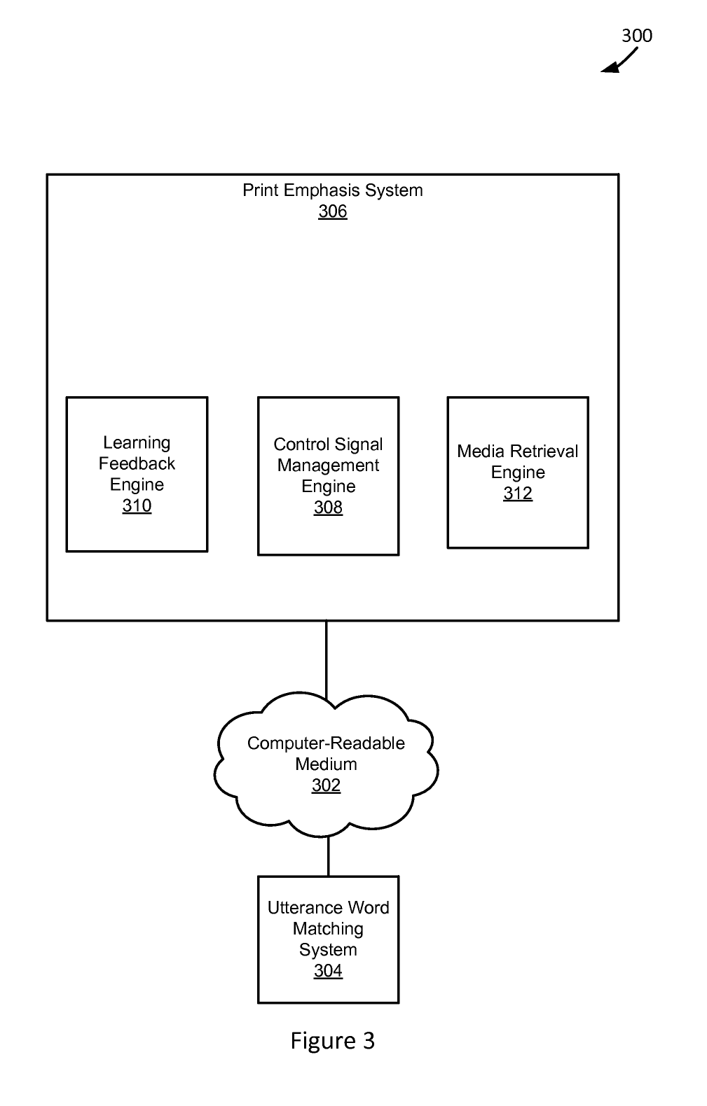

FIG. 3 depicts a diagram 300 of an example of a system for generating an instruction to emphasize a visual reference of a word displayed at a user device and read aloud by a user. The example system shown in FIG. 3 includes a computer-readable medium 302, an utterance word matching system 304, and a print emphasis system 306. In the example system shown in FIG. 3, the utterance word matching system 304 and the print emphasis system 306 are coupled to each other through the computer-readable medium 302.

The utterance word matching system 304 functions according to an applicable system for matching utterances with words, such as the utterance word matching systems described in this paper. The utterance word matching system 304 can match utterances made by a user when reading a visual reference of a string of words. The utterance word matching system 304 can match utterances to specific words based on word associated utterance data. Depending upon implementation-specific or other considerations, the utterance word matching system 304 can use either or both signal processing based word matching and speech recognition based word matching to match utterances to words.

The print emphasis system 306 functions according to an applicable system for generating emphasis display signals, such as the print emphasis systems described in this paper. The print emphasis system 306 can generate an emphasis display signal used in emphasizing a visual reference of a word. The print emphasis system 306 can generate a continuous emphasis display signal used in emphasizing a visual reference of a string of words as a user reads the words.

The print emphasis system 306 includes a control signal management engine 308, a learning feedback engine 310, and a media retrieval engine 312. The control signal management engine 308 functions to manage emphasis display signals. In managing emphasis display signals, the control signal management engine 308 can generate an emphasis display signal instructing to emphasize a visual reference of a word when at least a portion of the word is uttered by a user. The control signal management engine 308 can generate an emphasis display signal based on an electrical audio signal of an utterance or utterances of a word by a user. The control signal management engine 308 can generate an emphasis display signal based on a word matched to utterances made by the user. For example, if utterances are matched to the word “elephant,” then the control signal management engine 308 can generate an emphasis display signal indicating to emphasize a visual reference of the word “elephant” in a display.

In a specific implementation, the control signal management engine 308 generates an emphasis display signal indicating to emphasize a visual reference of a word in a visual display of a string of words. Depending upon implementation-specific or other considerations, the control signal management engine 308 can generate a continuous emphasis display signal for a string of words as the words are uttered, in an order in which the words are uttered. An emphasis display signal generated by control signal management engine 308 for a string of words can be used to emphasize a visual representation of the words within a display of the words continuously as the words are read. An emphasis display signal is continuous in that it is continuously generated as a user reads words in a string of words to emphasize specific portions of a visual reference of the string of words, as the words are read by the user. For example, the control signal management engine 308 can continuously generate an emphasis display signal to emphasize a visual reference of each word in a visual reference of a string of words, as each word is read by a user.

In a specific implementation, the control signal management engine 308 generates an emphasis display signal indicating to emphasize a portion of a print display of a word as the word is read by a user. Depending upon implementation-specific or other considerations, the control signal management engine 308 can generate an emphasis display signal indicating to emphasize each syllable or letter of a word, as the word is read by a user. This allows a user to view each syllable as it is pronounced, to further aide in teaching a user how to read.

In a specific implementation, the control signal management engine 308 generates an emphasis display signal indicating to emphasize a visual representation of a meaning of a word. Depending upon implementation-specific or other considerations, the control signal management engine 308 can generate an emphasis display signal indicating to emphasize a visual representation of a meaning of a word as the word is read or after the word is read. For example, the control signal management engine 308 can generate an emphasis display signal indicating to emphasize a displayed picture of an elephant, after the word “elephant” is read.

In a specific implementation, the control signal management engine 308 generate an emphasis display signal indicating to deemphasize a visual reference of a word. The control signal management engine 308 can generate an emphasis display signal to deemphasize a visual reference of a word if a word is improperly matched with utterances made by a user. For example, if utterances are initially match with the word “elephant,” and the control signal management engine 308 generates an emphasis display signal indicating to emphasize a print display of the word “elephant,” letter by letter, and it is found that the utterances have been improperly matched to the word “elephant,” then the control signal management engine 308 can an emphasis display signal indicating to stop emphasizing the print display of the word elephant.

The learning feedback management engine 310 functions to manage feedback for helping a user learn how to read. Feedback can include applicable feedback for aiding a user in learning how to read. For example, feedback can include audio of an enunciation of a word, a meaning of a word, and a visual representation of an audio electrical signal of an utterance made by a user. The learning feedback management engine 310 can provide the feedback to a user device utilized by the user, where it can be perceived by the user. In various implementations, the learning feedback engine 310 can provide feedback based on words matched to utterances made by a user.

In a specific implementation, the learning feedback management engine 310 functions to generate an electrical audio signal used in producing a sound of a word or a portion of the word. The learning feedback management engine 310 can generate an electrical audio signal used in producing a sound of a word or a portion of the word at a user device and subsequently send the electrical audio signal to the user device. The electrical audio signal can be used to produce a sound of a word or a portion of the word at the user device to facilitate learning. The learning feedback management engine 310 can generate an electrical audio signal as feedback based upon a word matched to utterances made by a user. For example, if utterances are matched to the word “elephant,” then the learning feedback management engine 310 can provide an electrical audio signal of the enunciation of the word “elephant.”

In a specific implementation, the learning feedback management engine 310 functions to generate an electrical audio signal used in producing a sound of a word or a portion of the word in response to the word or the portion of the word being uttered by a user. Depending upon implementation-specific or other considerations, the learning feedback management engine 310 can generate an audio signal used in producing a sound of an utterance of a word or a portion of a word as spoken by a user. For example, the learning feedback management engine 310 can generate an electrical audio signal used in reproducing the utterance of a user in speaking a word or a portion of a word.

In a specific implementation, the learning feedback management engine 310 functions to generate display data used in displaying a visual representation of an electrical audio signal of utterances made by a user. Depending upon implementation-specific or other considerations, display data generated by the learning feedback management engine 310 can include data used in displaying a visual representation of an actual electrical audio signal of utterances made by a user or a processed version of the actual electrical audio signal. Further depending upon implementation-specific or other considerations, display data generated by the learning feedback management engine 310 can include an expected electrical audio signal associated with a word, a portion of a word, or a plurality of words matched to an utterance made by a user using word associated utterance data.

In a specific implementation, the learning feedback management engine 310 functions to provide media to a user device. Media provided by the learning feedback management engine 310 can be included as part of display data. For example, the learning feedback management engine 310 can provide display data including media depicting a visual representation of a meaning of a word. The learning feedback management engine 310 can provide media depicting a visual representation of a meaning of a word with triggers for displaying the media. For example, display data generated by the learning feedback engine 310 can include a trigger to display twinkling stars when “twinkle twinkle little star” is spoken.

The media retrieval engine 312 functions to gather media. Media gathered by the media retrieval engine 312 can be included as part of display data sent to a user device. For example, media gathered by the media retrieval engine 312 can include a visual representation of a meaning of a word. Media can include audio related to a meaning of a word. For example, if a word is “elephant,” then media gathered by the media retrieval engine can include a roar of an elephant. The media retrieval engine 312 can retrieve media corresponding to a word matched to utterances made by a user. For example, if utterances are matched to the word “elephant,” then the media retrieval engine 312 can retrieve an image of an elephant.

In an example of operation of the example system shown in FIG. 3, the utterance word matching system 304 matches utterances made by a user to a word. In the example of operation of the example system shown in FIG. 3, the control signal management engine 308 generates an emphasis display signal indicating to emphasize a visual reference of the word at a user device based on the match made by the utterance word matching system 304. Further, in the example of operation of the example system shown in FIG. 3, the learning feedback engine 310 provides feedback to assist a user in learning how to read based on the match made by the utterance word matching system 304. In the example of operation of the example system shown in FIG. 3, the media retrieval engine 312 acquires media based on the match made by the utterance word matching system 304.

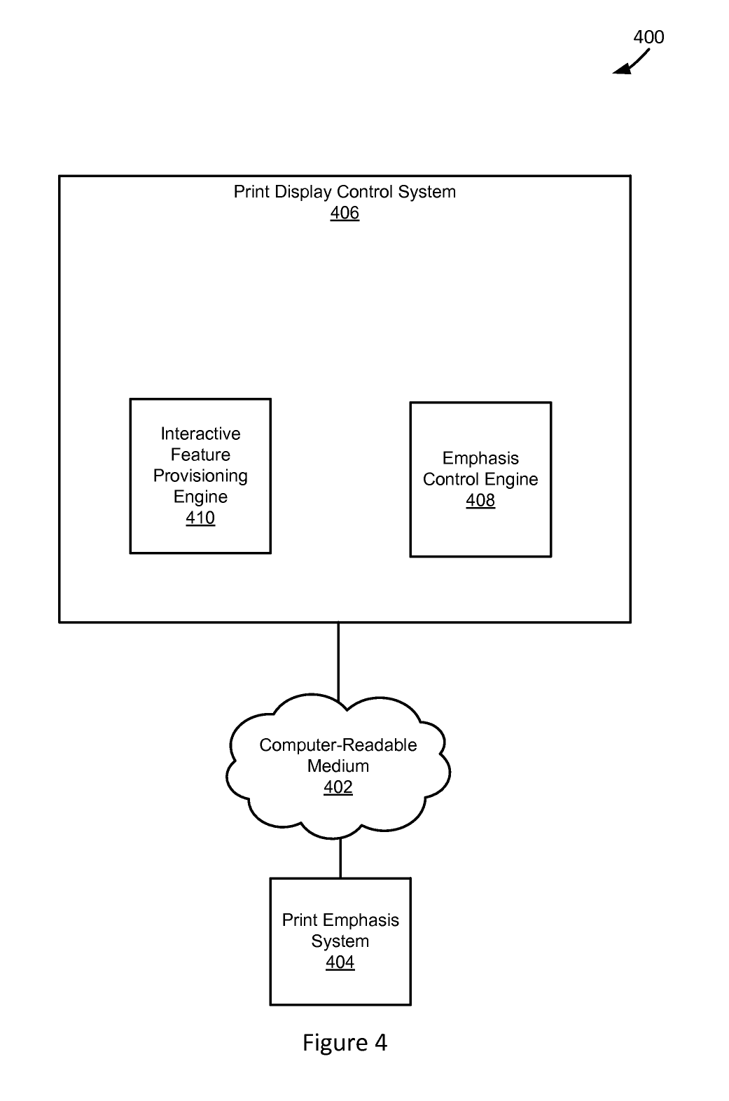

FIG. 4 depicts a diagram 400 of an example of a system for controlling emphasis of visual references at a user device. The example system shown in FIG. 4 includes a computer-readable medium 402, a print emphasis system 404, and a print display control system 406. In the example system shown in FIG. 4, the print emphasis system 404 and the print display control system 406 are coupled to each other through the computer-readable medium 402.

The print emphasis system 404 functions according to an applicable system for determining visual references to emphasize, such as the print emphasis systems described in this paper. The print emphasis system 404 can determine visual references to emphasize based on words matched to utterances made by a user. Depending upon implementation-specific or other considerations, words can be matched to utterances through either or both signal processing techniques and speech recognition techniques.

The print display control system 406 functions according to an applicable system for controlling a display of words read by a user, such as the print display control systems described in this paper. In various implementations, the print display control system 406 can be integrated with a user device. A display of words read by a user can be displayed from text data, e.g. an EBook. In controlling a display of words, the print display control system 406 can emphasize a visual reference of a word according to received emphasis display signals. In various implementations, the print display control system 406 can deemphasize a visual reference of a word according to received emphasis display signals.

The print display control system 406 includes an emphasis control engine 408 and an interactive feature provisioning engine 410. The emphasis control engine 408 functions to control emphasis of a visual reference of a word in a display of words at a user device. The emphasis control engine 408 can emphasize a visual reference of a word according to emphasis display signals. In various implementations, the emphasis control engine 408 can emphasize a print display of a word or a visual representation of a meaning of a word.

In a specific implementation, the emphasis control engine 408 can emphasize a visual reference of a word according to emphasis instructions. Emphasis instructions can specify a way of emphasizing words, e.g. by increasing a visual prominence of a visual reference of a word, such as modifying either or both a background of the print display or the word or other words within the print display, or by displaying or accentuating a visual representation of a meaning of the word. Depending upon implementation-specific or other considerations, emphasis instructions can be included as part of emphasis display signals and/or based on input from a user. For example, a user can specify to emphasize words by changing them to a specific color, and the emphasis control engine 408 can emphasize the words by changing them to the specific color.

The interactive feature provisioning engine 410 functions to provide interactive features to a user in viewing a display of words at a user device. In various implementations, the interactive feature provisioning engine 410 provides options for the user to pause, stop, or resume emphasis of visual references of words in a display of words. In providing pause, stop, or resume features, the interactive feature provisioning engine 410 can instruct the emphasis control engine 408 whether to pause, stop, or resume. In various implementations, the interactive feature provisioning engine 410 can display a new page of words in response to a user finishing reading words in a display at a user device.

In a specific implementation, the interactive feature provisioning engine 410 can provide interactive feature in response to triggers received at part of display data. For example if a trigger specifies to show an image of an elephant when the word “elephant” is read, then the interactive feature provisioning engine 410 can display an image of an elephant when the word “elephant” is read.

In an example of operation of the example system shown in FIG. 4, the print emphasis system 404 generates emphasis display signals based on words matched to utterances made by a user in reading words in a display at a user device. In the example of operation of the example system shown in FIG. 4, the emphasis control engine 408 controls emphasis of visual references of the words in the display based on the emphasis display signals. Further, in the example of operation of the example system shown in FIG. 4, the interactive feature provisioning engine 410 provides interactive features to the user in reading the words in the display.

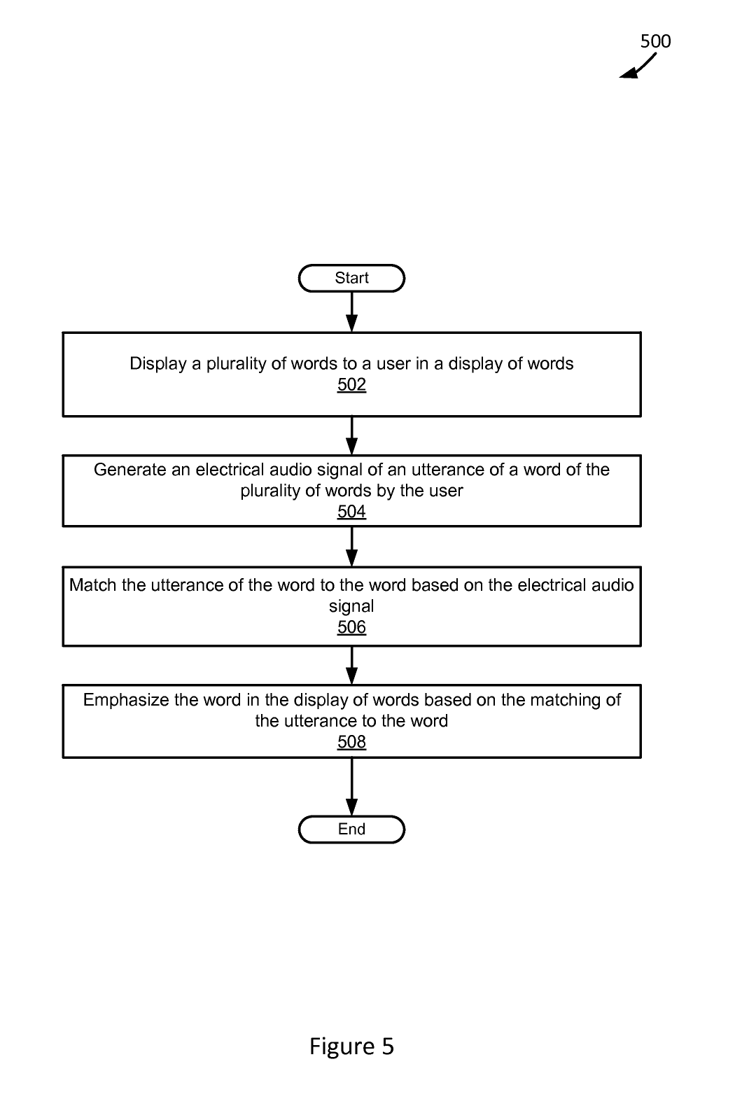

FIG. 5 depicts a flowchart 500 of an example of a method for enhancing a display of uttered words. The flowchart 500 begins at module 502 where a plurality of words is displayed to a user in a display of words. The plurality of words can be displayed in response to text data. Text data can be included as part of data of an EBook. A plurality of words can be displayed to a user device through a user device of the user.

The flowchart 500 continues to module 504 where an electrical audio signal of the user uttering a word of the plurality of words is generated. An electrical audio signal can be generated by an applicable device for generating an electrical audio signal in response to sound, such as an acoustoelectric transducer. Depending upon implementation-specific or other considerations, an electrical audio signal can be generated as the user speaks a word of the plurality of words.

The flowchart 500 continues to module 506, where the utterance of the word is matched to the word based on the electrical audio signal. The utterance of the word can be matched to the word using word associated utterance data. The utterance of the word can be matched to the word by matching the electrical audio signal representing the utterance of the word to an expected electrical audio signal of the word, included as part of word associated utterance data. Depending upon implementation-specific or other considerations, the electrical audio signal can be matched to an expected audio electrical signal according to an applicable technique for matching signals. Further depending upon implementation-specific or other considerations, applicable signal processing can be performed to facilitate matching the electrical audio signal to an expected audio electrical signal.

The flowchart 500 continues to module 508, where the word is emphasized in the display of words based on the matching of the utterance to the word. In emphasizing the word in the display of words based on the matching of the utterance to the word, the word can be emphasized only if the utterance of the word is matched to the word. Depending upon implementation-specific or other considerations, the word can be emphasized in the display of words after the user utters the word, and before the user utters a next word of the plurality of words. In emphasizing the word in the display of words, the visual prominence of the word in the display of words can be increased according to an applicable technique for increasing visual prominence of words in a display of words, e.g. highlighting the word.

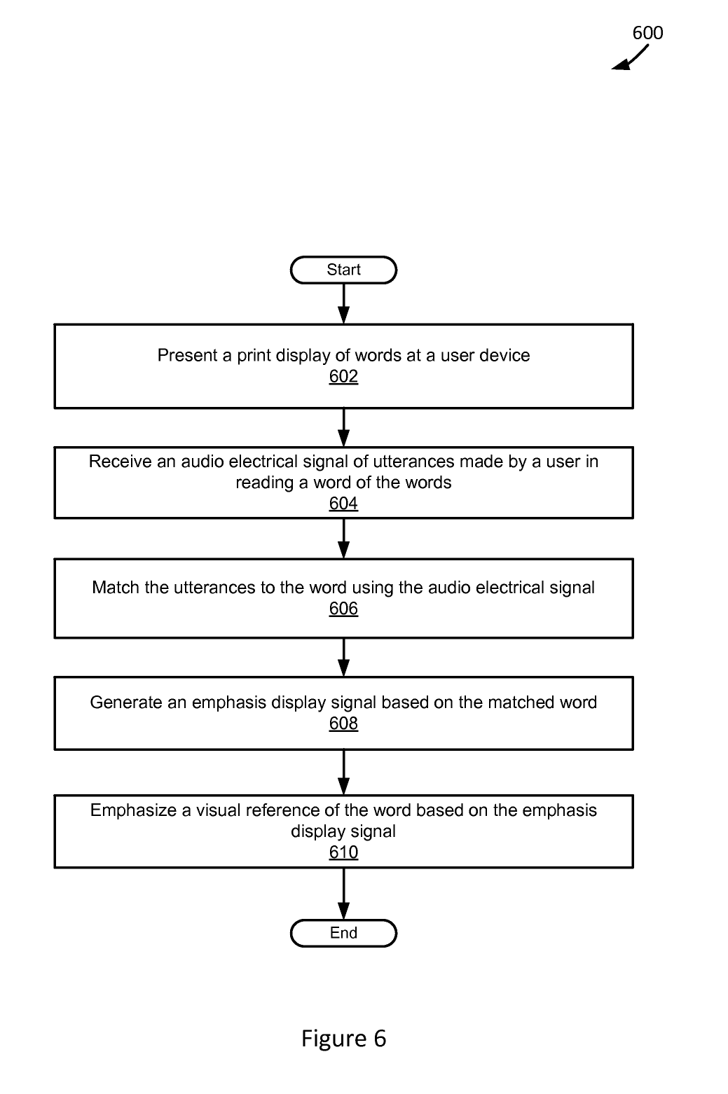

FIG. 6 depicts a flowchart 600 of an example of a method for enhancing a visual reference of a word in a display of words. The flowchart 600 begins at module 602, where a print display of words is presented at a user device. The display of words can be indicated by text data as part of an EBook.

The flowchart 600 continues to module 604, where an audio electrical signal of utterances made by a user in reading a word of the words is received. An audio electrical signal can be generated by an applicable device for generating an audio electrical signal of utterances made by a user, such as the acoustoelectric transducers described in this paper.

The flowchart 600 continues to module 606, where the utterances are matched to the word using the audio electrical signal. Depending upon implementation-specific or other considerations, the utterances can be matched to the word through signal processing techniques. An applicable engine for matching utterances to words based on signal processing techniques, such as the signal processing based word matching engines described in this paper, can match the utterances to the word using signal processing techniques. Further depending upon implementation-specific or other considerations, the utterances can be matched to the word through speech recognition techniques. An applicable engine for matching utterances to words based on speech recognition, such as the speech recognition based word matching engines described in this paper, can match the utterances to the word using speech recognition techniques.

The flowchart 600 continues to module 608, where an emphasis display signal is generated based on the match of the utterances to the word. An emphasis display signal can indicate to emphasize a visual reference of the word in the display of words. An applicable engine for generating an emphasis display signal, such as the control signal management engines described in this paper, can generate an emphasis display signal based on the match of the utterances to the word. Depending upon implementation-specific or other considerations, the emphasis display signal can specify to emphasize a print display of a word and/or a visual representation of a meaning of a word.

The flowchart 600 continues to module 610, where a visual reference of the word is emphasized based on the emphasis display signal. An applicable engine for emphasizing a visual reference of a word, such as the emphasis control engines described in this paper, can emphasize a visual reference of the word according to the emphasis display signal. Depending upon implementation-specific or other considerations, a print display of a word and/or a visual representation of a meaning of a word can be emphasized according to the emphasis display signal.

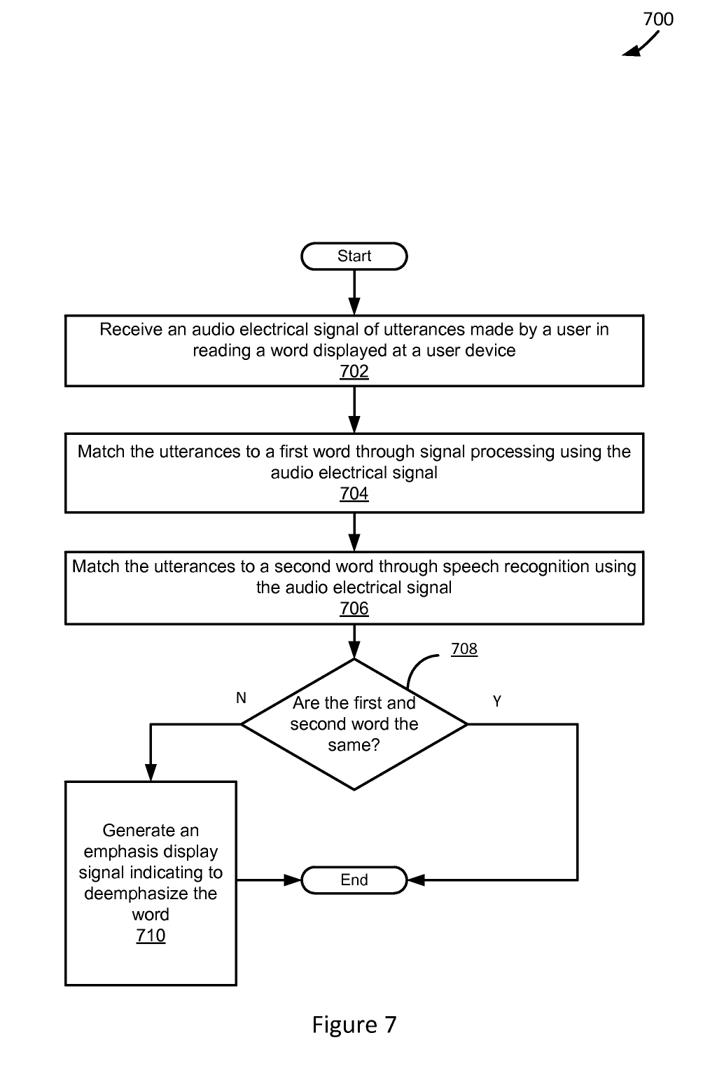

FIG. 7 depicts a flowchart 700 of an example of a method for determining if an enhanced visual reference is for a word that is being uttered by a user. The flowchart 700 begins at module 702, where an audio electrical signal of utterances made by a user in reading a word displayed at a user device is received. An audio electrical signal can be generated by an applicable device for generating an audio electrical signal of utterances made by a user, such as the acoustoelectric transducers described in this paper.

The flowchart 700 continues to module 704, where the utterances are matched to a first word through signal processing using the audio electrical signal. An applicable engine for matching a word to utterances through signal processing techniques, such as the signal processing based word matching engines described in this paper, can match the utterances to a first word using signal processing techniques. For example, a waveform of the audio electrical signal can be compared to waveforms of audio electrical signals associated with specific words in order to match the utterances with a first word.

The flowchart 700 continues to module 706, where the utterances are matched to a second word through speech recognition using the audio electrical signal. An applicable engine for matching a word to utterances through speech recognition techniques, such as the speech recognition based word matching engines described in this paper, can match the utterances to a second word using speech recognition techniques. For example, the utterances can be compared to patterns of utterances associated with specific words, to match the utterances with a second word.

The flowchart 700 continues to decision point 708. At decision point 708, it is determined whether the first word and the second word are the same. If it is determined that the first word and the second word are not the same, thereby indicating an error in matching of the utterances to words, then the flowchart 700 continues to module 710. At module 710, the flowchart includes generating an emphasis display signal indicating to deemphasize an emphasized displayed word. The emphasized displayed word can be either the first word or the second word.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
presenting a print display of words in a display at a user device;
generating an audio electrical signal based on utterances of a user in speaking a word of the words;
matching the utterances to the word using the audio electrical signal and word associated utterance data;
generating an emphasis display signal based on the matching of the utterances to the word;
emphasizing a visual reference of the word at the display based on the emphasis display signal.

2. The method of claim 1, wherein the utterances are matched to the word using signal processing.

3. The method of claim 1, wherein the word associated utterance data includes waveforms of audio electrical signals associated with specific words, including the word, and the utterances are matched to the word by comparing a waveform of the audio electrical signal and the waveforms of the audio electrical signals associated with the specific words.

4. The method of claim 1, wherein the utterances are matched to the word using speech recognition.

5. The method of claim 1, wherein the word associated utterance data includes patterns of utterances associated with specific words, including the word, and the utterances are matched to the word by comparing a pattern of the utterances and the patterns of utterances associated with the specific words.

6. The method of claim 1, further comprising:
modifying the word associated utterance data based on the utterances of the user to generate modified word associated utterance data;
utilizing the modified word associated utterance data to match additional utterances made by the user to additional words.

7. The method of claim 1, wherein the visual reference of the word at the display is a print display of the word in the print display of words.

8. The method of claim 1, wherein the visual reference of the word at the display is a visual representation of a meaning of the word.

9. The method of claim 1, wherein the visual reference of the word at the display is a print display of the word in the print display of words and the word is emphasized syllable by syllable of the word.

10. The method of claim 1, further comprising:
generating an audio electrical signal of the enunciation of the word;
using the audio electrical signal of the enunciation of the word to play at the user device an audio sound of a pronunciation of the word.

11. A system comprising:
a user device configured to present a print display of words in a display;
an acoustoelectric transducer configured to generate an audio electrical signal based on utterances of a user in speaking a word of the words;
an utterance word matching machine configured to match the utterances to the word using the audio electrical signal and word associated utterance data;
a control signal management engine configured to generate an emphasis display signal based on the matching of the utterances to the word;
an emphasis control engine configured to emphasize a visual reference of the word at the display based on the emphasis display signal.

12. The system of claim 11, wherein the utterances are matched to the word using signal processing.

13. The system of claim 11, wherein the word associated utterance data includes waveforms of audio electrical signals associated with specific words, including the word, and the system further comprising a signal processing based word matching engine configured to match the utterances to the word by comparing a waveform of the audio electrical signal and the waveforms of the audio electrical signals associated with the specific words.

14. The system of claim 11, wherein the utterances are matched to the word using speech recognition.

15. The system of claim 11, wherein the word associated utterance data includes patterns of utterances associated with specific words, including the word, and the system further comprising a speech recognition based word matching engine configured to match the utterances to the word by comparing a pattern of the utterances and the patterns of utterances associated with the specific words.

16. The system of claim 11, further comprising:
a word associated utterance management engine configured to modify the word associated utterance data based on the utterances of the user to generate modified word associated utterance data;
the utterance word matching machine further configured to utilize the modified word associated utterance data to match additional utterances made by the user to additional words.

17. The system of claim 11, wherein the visual reference of the word at the display is a print display of the word in the print display of words.

18. The system of claim 11, wherein the visual reference of the word at the display is a visual representation of a meaning of the word.

19. The system of claim 11, wherein the visual reference of the word at the display is a print display of the word in the print display of words and the word is emphasized syllable by syllable of the word.

20. The system of claim 1, further comprising:
an interactive feature provisioning engine configured to generate an audio electrical signal of the enunciation of the word;
the user device further configured to use the audio electrical signal of the enunciation of the word to play at the user device an audio sound of a pronunciation of the word.

21. A system comprising:
means for presenting a print display of words in a display at a user device;
means for generating an audio electrical signal based on utterances of a user in speaking a word of the words;
means for matching the utterances to the word using the audio electrical signal and word associated utterance data;
means for generating an emphasis display signal based on the matching of the utterances to the word;
means for emphasizing a visual reference of the word at the display based on the emphasis display signal.
